(19) United States
(12) Patent Application Publication
(10) Pub. No.: US 2002/0040027 A1
(43) Pub. Date: Apr. 4, 2002

(54) Method for the prevention of the reinfestation of warm-blooded animals by ectoparasites

(76) Inventors: Friedrich Karrer, Zofingen (CH); Thomas Gobel, Lorrach (DE); Elaine Humbert-Droz, Ponthaux (CH)

Correspondence Address: THOMAS HOXIE, NOVARTIS CORPORATION, PATENT AND TRADEMARK DEPT, 564 MORRIS AVENUE, SUMMIT, NJ, 079011027

(21) Appl. No.: 09/971,836

(22) Filed: Oct. 5, 2001

Related U.S. Application Data
(63) Continuation of application No. 09/284,645, filed on Apr. 8, 1999.
Application No. 09/284,645 is a 371 of international application No. PCT/EP97/05639, filed on Oct. 14, 1997.

(30) Foreign Application Priority Data
Oct. 16, 1996 (CH) 2525/96

(51) Int. Cl. A01N 43/66; A01N 43/58; A01N 43/54; A01N 43/40; A01N 43/32; A01N 43/30

(52) U.S. Cl. 514/241; 514/464; 514/247; 514/252.1; 514/256; 514/345; 514/452

(57) ABSTRACT

A method for the systemic control of blood-sucking parasites in warm-blooded animals or for the prevention of reinfestation, which comprises administering systemically to the warm-blooded animal a compound of formula

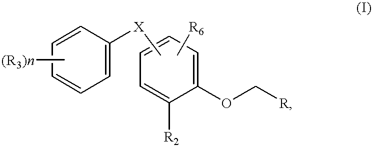

wherein R, R₂, R₃, R₆, X and n are as defined in claim 1, in an amount that affects the growth of one of the early stages of development of the parasite in such a manner that the parasite does not reach the adult stage or that the adult parasite is rendered sterile.

This is a continuation of Ser. No. 09/284,645, Apr. 8, 1999, which is a 371 of PCT/EP97/05639, Oct. 14, 1997.

The present invention relates to the use of compounds of formula I in the systemic control of ectoparasites in warm-blooded animals, especially dogs and cats.

Blood-sucking ectoparasites of the order Insecta, which include, for example, Ctenocephalides felis and C. canis (cat and dog fleas), lice, mosquitos, tabanids, tsetse-flies and other biting flies, and those of the order Acarina, such as, for example, Boophilus, Amblyomma, Anocentor, Dermacentor, Haemaphysalis, Hyalomma, Ixodes, Rhipicentor, Margaropus, Rhipicephalus, Argas, Otobius and Ornithodorus (ticks) and the like, infest many warm-blooded animals, including farm animals, such as cows, pigs, sheep and goats, fowl, such as hens, turkeys and geese, animals bred for their fur, such as mink, foxes, chinchillas, rabbits and the like, and domestic animals, such as cats and dogs.

Ticks can be subdivided into hard and soft ticks and are characterised by the fact that they infest one, two or three host animals. They attach themselves to a suitable host animal and suck up blood or body fluid. Replete female ticks drop from the host animal and lay large numbers of eggs (2000 to 3000) in a suitable niche in the ground or in any other protected site, where the larvae hatch. The larvae in turn seek a host animal, in order to suck its blood. Larvae of ticks that infest only one host animal moult twice and, in so doing, become nymphs and, finally, adult ticks without leaving the host that was first chosen. Larvae of ticks that infest two or three host animals drop from the host animal after ingesting the blood, moult in the surrounding area and, as nymphs or adult ticks, seek a second or third host in order to suck its blood.

Ticks are responsible for transmitting and passing on many human and animal diseases throughout the world. The most important ticks, on account of their economic consequences, are Boophilus, Rhipicephalus, Ixodes, Hyalomma, Amblyomma and Dermacentor. They are carriers of bacterial, viral, rickettsial and protozoal diseases and cause tick-paralysis and tick-toxicosis. Even a single tick can cause paralysis as its saliva passes into the host animal as the tick takes in food. Diseases caused by ticks are usually transmitted by ticks that infest several host animals. Such diseases, for example babesiosis, anaplasmosis, theileriasis and heartwater, are responsible for death or injury in a large number of domestic and farm animals all over the world. In many countries having a temperate climate, ixodid ticks pass the agent of the chronically destructive lyme disease from wild animals to humans. In addition to transmitting diseases, ticks are also responsible for high economic losses in cattle production. The losses are attributable not only to the death of the host animals, but also to damage to the skins, loss of growth, reduction in milk production and reduced value of the meat. Although the harmful effects of tick infestation in animals have been known for many years and enormous progress has been made in tick-control programmes, no totally satisfactory methods of controlling or eliminating those parasites have yet been found and, in addition, ticks have often developed a resistance to chemical active ingredients.

Likewise, flea infestation in domestic animals and pets is a problem for the animal owner to which there have as yet been found only unsatisfactory solutions. Owing to the complicated life cycle of the flea, none of the known methods of controlling fleas is totally satisfactory, especially since most of the known methods are aimed principally at controlling the fully grown fleas in the fur and take no account at all of the various juvenile stages of the fleas, which live not only in the fur of the animal, but also on the floor, on carpets, on the animal's sleeping place, on chairs, in the garden and in all the other places with which the infested animal comes into contact. Adult cat and dog fleas (Ctenocephalides felis and C. canis) normally live in the fur of the host cat or host dog. They live on the blood of the host animal and lay their eggs in its fur. Since those eggs are not self-adhering, however, they generally soon fall off and can be found on the floor, on carpets, in the dog's or cat's basket, on the chairs used by the animal, in the garden, in the yard, etc..

That means that the whole of the pets' living area is contaminated with flea eggs, from which the larvae develop within two days. The larvae have three distinct stages of development, each of which lasts three days. In the final stage the larva spins its cocoon and becomes a pupa. Under favourable conditions, i.e. at 33° C. and a relative humidity of 65%, the metamorphosis from egg to pupa takes place in about 8 to 10 days. After about another 8 days the young, fully-formed fleas develop in the cocoons that are still lying on the floor, the carpets, the sleeping places, the chairs, etc. The young adult fleas remain there until they sense the presence of an acceptable host animal, then they hatch from their cocoons and attempt to jump onto the host animal. Thus it takes at least three weeks for an egg to develop into a young adult flea that is capable of reinfesting the host animal.

The young flea may, however, remain in its cocoon for months, possibly for up to a year. On the other hand, under less favourable conditions the development from egg to young adult flea may take 4 to 5 months. To reach sexual maturity, fleas require blood as food in order to be able to reproduce, and that blood must be from the appropriate host animal.

That long-life cycle, which proceeds separately from the host animal, has a significant influence on the successful control of fleas on the host animal.

Even when the fleas in the fur of the host animal can be successfully controlled, i.e. when all the adult fleas are killed with a suitable active ingredient, the cat or the dog is nevertheless exposed for weeks or even months to the risk of reinfestation by newly hatched young fleas from its living space.

Flea infestation of dogs and cats has unpleasant consequences not only for the animal to be treated but also for the animal's owner. Such drawbacks lead, for example, to local irritation or troublesome itching. A large number of animals become allergic to the excreta of the fleas, which leads to very itchy and crusty skin changes around the sites of the bites on the animal's body. Those skin changes normally have a diameter of approximately 3 mm or more and often make the animal prone to biting and cause it to scratch, leading to loss of fur in places.

Furthermore, flea-infested animals are constantly exposed to the risk of infestation by Dipylidium caninum, a type of tape worm, which is transmitted by fleas.

Flea infestation is not only extremely troublesome for the affected animal, but also has unpleasant consequences for the animal's owner, until it finally becomes evident to him from the unusual behaviour of his pet that it is ill and is suffering and that he must help it. What is more, it can become unpleasant for the animal's owner if he has to give up keeping his infested animal, or if it dies or is removed temporarily from its usual environment, since in the event of the prolonged absence of a suitable host animal, the newly hatched fleas on the floor will be forced to infest the human, although they are unable to reproduce with human blood as their only source of food. Even when the dog or the cat is present, the animal's owner can be bitten by the fleas.

In addition, dog and cat fleas, or their excreta, can lead to allergy-like skin disorders in some people, which in many cases means that the pet must be destroyed. The desire for effective control of fleas in dogs and cats has therefore always existed.

A number of conventional methods of control are known, but they have various disadvantages. If, for example, flea combs are used, the animal's owner has no alternative but to comb the animal intensively and often which, depending on the size of the animal, may take from a few minutes to an hour and will not be accepted patiently by every animal. However, not every animal owner is prepared to devote the time to this. The use of corresponding anti-flea shampoos is often unsuccessful, since most cats, and also many dogs, can be bathed, if at all, only by force, with the result that water and medicament are spilt and have to be cleared up. In addition, the effect of such a bath treatment lasts about a week at most, and the laborious procedure has to be repeated. The same or very similar problems can be expected with the use of dips or rinses. The use of dusting powders is generally also not accepted by the animal without resistance, since it takes several minutes to treat the whole surface of the fur uniformly, and some of the dust will inevitably get into the mouth, nose and eyes of the animal. Even with careful application, it cannot be ensured that the animal and the human will not inhale any powder. It is virtually inevitable that the human will also come into contact with the composition to a greater or lesser extent.

When using sprays, many people may be unpleasantly surprised to find that most animals, especially cats, run away or react aggressively at the mere sound of the spray. In addition, sprays also have all the disadvantages listed for dusting powders, added to which they become even more finely dispersed in the atmosphere and are therefore inhaled by human and animal. Fleas are frequently controlled by means of so-called flea collars, which ensure good effectiveness temporarily. This treatment has a certain weakness, owing especially to its locally very limited area of application. Although the killing action in the region of the neck and chest is generally 100%, more remote parts of the body are scarcely affected. In addition, those collars are active for a limited time. Furthermore, many of the collars are unattractive and may annoy the animal. It is also possible nowadays to buy medallions, which can be hung from conventional collars and are said to be effective. Although they are attractive in appearance, the action of those medallions is unsatisfactory, since they have inadequate contact with the fur. Some anti-flea organophosphorus compounds are also available as spot-on formulations and are thus applied to a locally limited area of the fur. They generally have good short-term activity against adult fleas, but the compositions used often have toxic properties that present problems. Some organophosphorus compounds are also administered orally, but they are subject to strict safety restrictions and must on no account be administered simultaneously with other organophosphorus compounds.

Overall it may be said that most of the conventional methods seek only to kill the adult pest and, in some cases, they control that pest completely satisfactorily in the short term. However, what has hitherto not adequately been taken into account in the case of most of the known pest control methods is the fact that, owing to the particular life cycle of those ectoparasites, dogs and cats are repeatedly reinfested, partly because contact with the eggs, larvae and young adult fleas and ticks on the floor or in the immediate vicinity of the animal is unavoidable, and partly because many pet animals constantly come into contact with infested members of their own species. Constantly recurring reinfestation is not prevented by most conventional compositions.

In addition to numerous insecticidal compositions for controlling ectoparasites, systemically active agents have, therefore, also been proposed for some time, for example pyrethroids (U.S. Pat. Nos. 3,962,458 and 4,031,239), octahydrophenanthridines (U.S. Pat. No. 4,006,236), α-cyano-m-phenoxybenzyl-α-alkylnaphthalene-2-acetates (U.S. Pat. No. 4,053,631), alkanolamines (U.S. Pat. No. 4,323,582) and triazine and benzoylurea derivatives (U.S. Pat. No. 4,973,589). Some juvenile-hormone-like classes of nitrogen heterocycles have also been described as having systemic activity (U.S. Pat. No. 5,439,924).

Surprisingly, it has now been found that the compounds of formula

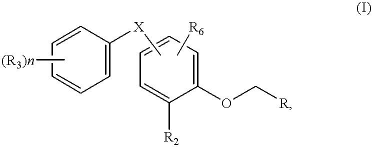

wherein

n is 0, 1, 2 or 3, and when n is greater than 1 the radicals R₃ are identical or different;

R is C(CH₃)═CHCOOR₇, wherein R₇ is C₁-C₆alkyl; C(CH₃)═CHC(═O)R₈, wherein R₈ is C₁-C₆alkyl, NH-C₁-C₆alkyl or N(C₁-C₆alkyl)₂; CH₂C(CH₃)(R₉)-OR₁₀, wherein R₉ and R₁₀ are each independently of the other H or C₁-C₆alkyl; phenyl that is substituted from one to five times, the substituents being selected from the group consisting of hydrogen, C₁-C₆alkyl, C₁-C₆alkoxy and halogen; pyridyl that is unsubstituted or substituted from one to four times, the substituents being selected from the group consisting of hydrogen, C₁-C₆alkyl and halogen; CH(R₁₁)OC(═O)NHR₁₂, wherein R₁₁ is hydrogen or methyl and R₁₂ is C₁-C₆alkyl; CH₂OC(═O)N(R₁₃)R₁₄, wherein R₁₃ and R₁₄ are each independently of the other hydrogen or C₁-C₆alkyl; CH₂NHCOOR₁₅, wherein R₁₅ is C₁-C₆alkyl; CH₂CH₂C≡CH; C≡CH; CH(R₁₆)ZR₁₇, wherein R₁₆ is hydrogen or C₁-C₆alkyl, Z is oxygen or sulfur and R₁₇ is a five- or six-membered, aromatic or non-aromatic ring containing from one to three nitrogen atoms;

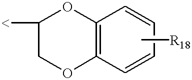

, wherein R₁₈ is hydrogen or C₁-C₆alkyl; 1,4-dioxane that is unsubstituted or substituted from one to seven times by C₁-C₆alkyl; or

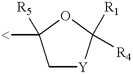

, wherein either R₁ is C₁-C₆alkyl, halo-C₁-C₃alkyl, C₂-C₄alkenyl, C₂-C₄alkynyl, C₁-C₃alkoxy or C₃-C₆cycloalkyl and R₄ is hydrogen or C₁-C₃alkyl; or R₁ and R₄, together with the carbon atom to which R₁ and R₄ are bonded, form a ring having 4, 5 or 6 ring members, the ring structure, which may contain a carbon-carbon double bond, being composed either only of carbon atoms or of 1 oxygen atom and 3, 4 or 5 carbon atoms and the ring being unsubstituted or mono- or di-substituted by identical or different C₁-C₃alkyl radicals; R₅ is hydrogen or C₁-C₃alkyl; and Y is nitrogen, oxygen or sulfur;

R₂ is hydrogen, C₁-C₃alkyl, halo-C₁-C₃alkyl, C₂-C₃alkenyl, C₁-C₃alkoxy, halo-C₁-C₃alkoxy, fluorine, chlorine or bromine;

R₃ is C₁-C₃alkyl, halo-C₁-C₃alkyl, C₁-C₃alkoxy, halo-C₁-C₃alkoxy, fluorine, chlorine or bromine;

R₆ is hydrogen, halogen or C₁-C₃alkyl; and

X is methylene, O, S or C(═O), have systemic activity in the control of ectoparasites in warm-blooded animals. When administered in very small doses to test animals, the compounds exhibit high ovicidal activity against ectoparasites. The term “ectoparasite”, as used here, has its normal meaning according to the prior art and includes fleas, ticks, lice, mosquitos, tabanids, tsetse-flies and other biting flies and, especially, the above-mentioned species.

Unless defined otherwise, the general terms used hereinbefore and hereinafter have the meanings given below.

The halogen atoms that come into consideration as substituents of haloalkyl and haloalkoxy are fluorine and chlorine as well as bromine and iodine, with fluorine, chlorine and bromine being preferred.

Unless defined otherwise, carbon-containing groups and compounds preferably each contain from 1 up to and including 4, especially 1 or 2, carbon atoms.

C₃-C₆Cycloalkyl is cyclopropyl, cyclobutyl, cyclopentyl or cyclohexyl.

Alkyl—as a group per se and as a structural element of other groups and compounds, such as alkoxy, haloalkyl and haloalkoxy—is, in each case giving due consideration to the number of carbon atoms contained in the group or compound in question, either straight-chained or branched and is methyl, ethyl, propyl, isopropyl, butyl, isobutyl, sec-butyl or tert-butyl, or pentyl or hexyl or in each case an isomer thereof. Preferred alkyl groups R₁ are C₁-C₃alkyl groups, especially C₂-C₃alkyl groups.

Alkenyl and alkynyl contain one or more, preferably not more than two, unsaturated carbon-carbon bonds. Examples that may be mentioned are vinyl, allyl, methallyl, prop-1-en-1-yl, 2-methyl-prop-1-en-1-yl, but-2-en-1-yl, ethynyl, propargyl, prop-1-yn-1-yl and but-1-yn-1-yl.

Halo-substituted groups, i.e. haloalkyl and haloalkoxy, may be partially halogenated or perhalogenated. Examples of haloalkyl—as a group per se and as a structural element of other groups and compounds, such as haloalkoxy—are methyl substituted from one to three times by fluorine, chlorine and/or by bromine, such as CHF₂ or CF₃; ethyl substituted from one to five times by fluorine, chlorine and/or by bromine, such as CH₂CH₂F, CH₂CF₃, CF₂CF₃, CF₂CCl₃, CF₂CHCl₂, CF₂CHF₂, CF₂CFCl₂, CF₂CHBr₂, CF₂CHClF, CF₂CHBrF or CClFCHClF; and propyl or isopropyl each substituted from one to seven times by fluorine, chlorine and/or by bromine, such as CH₂CHBrCH₂Br, CF₂CHFCF₃, CH₂CF₂CF₃ or CH(CF₃)₂.

Within the scope of the invention preference is given to

(1) compounds of formula

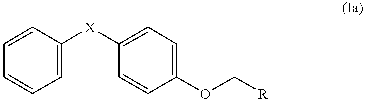

wherein R is C(CH₃)═CHCOOR₇, X is methylene or oxygen and R₇ is C₁-C₆alkyl;

(2) compounds of formula Ia wherein R is C(CH₃)═CHC(═O)R₈, X is methylene or oxygen and R₈ is C₁-C₆alkyl, NH-C₁-C₆alkyl or N(C₁-C₆alkyl)₂;

(3) compounds of formula Ia wherein R is CH₂C(CH₃)(R₉)-OR₁₀, X is methylene or oxygen and R₉ and R₁₀ are each independently of the other H or C₁-C₆alkyl;

(4) compounds of formula Ia wherein R is phenyl that is substituted from one to five times, the substituents being selected from the group consisting of hydrogen, C₁-C₆alkyl, C₁-C₆alkoxy and halogen, and X is methylene or oxygen;

(5) compounds of formula Ia wherein R is pyridyl that is unsubstituted or substituted from one to four times, the substituents being selected from the group consisting of hydrogen, C₁-C₆alkyl and halogen, and X is methylene or oxygen;

(6) compounds of formula Ia wherein R is CH(R₁₁)OC(═O)NHR₁₂, R₁₁ is hydrogen or methyl, R₁₂ is C₁-C₆alkyl and X is methylene or oxygen;

(7) compounds of formula

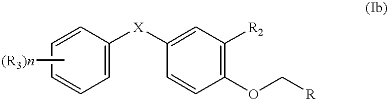

wherein R is CH₂OC(═O)N(R₁₃)R₁₄, R₂ is hydrogen, C₁-C₃alkyl, halo-C₁-C₃alkyl, C₁-C₃-alkoxy, halo-C₁-C₃alkoxy, fluorine, chlorine or bromine, R₃ is C₁-C₃alkyl, halo-C₁-C₃alkyl, C₁-C₃alkoxy, halo-C₁-C₃alkoxy, fluorine, chlorine or bromine, R₁₃ and R₁₄ are each independently of the other hydrogen or C₁-C₆alkyl, n is 0, 1 or 2, and when n is 2 the two radicals R₃ are identical or different, and X is methylene or oxygen;

(8) compounds of formula Ib wherein R is CH₂NHCOOR₁₅, R₂ is hydrogen, C₁-C₃alkyl, halo-C₁-C₃alkyl, C₁-C₃alkoxy, halo-C₁-C₃alkoxy, fluorine, chlorine or bromine, R₃ is C₁-C₃alkyl, halo-C₁-C₃alkyl, C₁-C₃alkoxy, halo-C₁-C₃alkoxy, fluorine, chlorine or bromine, R₁₅ is C₁-C₆alkyl, n is 0, 1 or 2, and when n is 2 the two radicals R₃ are identical or different, and X is methylene or oxygen;

(9) compounds of formula Ib wherein R is CH₂CH₂C≡CH or C≡CH, R₂ is hydrogen, C₁-C₃-alkyl, halo-C₁-C₃alkyl, C₁-C₃alkoxy, halo-C₁-C₃alkoxy, fluorine, chlorine or bromine, R₃ is C₁-C₃alkyl, halo-C₁-C₃alkyl, C₁-C₃alkoxy, halo-C₁-C₃alkoxy, fluorine, chlorine or bromine, n is 0, 1 or 2, and when n is 2 the two radicals R₃ are identical or different, and X is methylene or oxygen;

(10) compounds of formula Ib wherein R is CH(R₁₆)ZR₁₇, R₂ and R₁₆ are hydrogen, R₃ is C₁-C₃alkyl, halo-C₁-C₃alkyl, C₁-C₃alkoxy, halo-C₁-C₃alkoxy, fluorine, chlorine or bromine, n is 0, 1 or 2, and when n is 2 the two radicals R₃ are identical or different, R₁₇ is a five- or six-membered, aromatic or non-aromatic ring containing from one to three nitrogen atoms, X is methylene or oxygen and Z is oxygen or sulfur;

(11) compounds of formula Ib wherein R

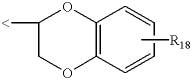

, R₂ and R₃ are hydrogen, R₁₈ is hydrogen or C₁-C₂-C₃alkenyl, C₆alkyl and X is methylene or oxygen;

(12) compounds of formula Ib wherein R is 1,4-dioxane that is unsubstituted or substituted from one to seven times by C₁-C₆alkyl, R₂ is hydrogen, R₃ is C₁-C₃alkyl, halo-C₁-C₃alkyl, C₁-C₃alkoxy, halo-C₁-C₃alkoxy, fluorine, chlorine or bromine, n is 0, 1 or 2, and when n is 2 the two radicals R₃ are identical or different, and X is methylene or oxygen;

(13) compounds of formula Ib wherein R is

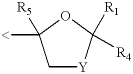

, wherein either R₁ is C₁-C₆-alkyl, halo-C₁-C₃alkyl, C₂-C₄alkenyl, C₂-C₄alkynyl, C₁-C₃alkoxy or C₃-C₆cycloalkyl and R₄ is hydrogen or C₁-C₃alkyl; or R₁ and R₄, together with the carbon atom to which R₁ and R₄ are bonded, form a ring having 4, 5 or 6 ring members, the ring structure, which may contain a carbon-carbon double bond, being composed either only of carbon atoms or of 1 oxygen atom and 3, 4 or 5 carbon atoms and the ring being unsubstituted or mono- or di-substituted by identical or different C₁-C₃alkyl radicals, R₂ is hydrogen, C₁-C₃alkyl, halo-C₁-C₃alkyl, C₁-C₃alkoxy, halo-C₁-C₃alkoxy, fluorine, chlorine or bromine, R₃ is C₁-C₃alkyl, halo-C₁-C₃alkyl, C₁-C₃alkoxy, halo-C₁-C₃alkoxy, fluorine, chlorine or bromine, n is 0, 1 or 2, and when n is 2 the two radicals R₃ are identical or different, X is methylene or oxygen, R₅ is hydrogen or C₁-C₃alkyl and Y is nitrogen, oxygen or sulfur;

(14) compounds of formula

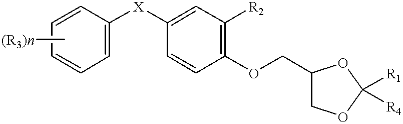

(Ic) wherein R₁ is C₁-C₄alkyl, vinyl or cyclopropyl, preferably C₁-C₃alkyl;

(15) compounds of formula Ic wherein R₂ is hydrogen, methyl, fluorine or chlorine, preferably hydrogen or chlorine;

(16) compounds of formula Ic wherein R₃ is fluorine or chlorine, preferably fluorine;

(17) compounds of formula Ic wherein R₄ is hydrogen or methyl, preferably hydrogen;

(18) compounds of formula Ic wherein X is oxygen or methylene, preferably oxygen;

(19) compounds of formula Ic wherein n is 0, 1 or 2, and when n is 2 the two radicals R₃ are identical or different; R₁ is C₁-C₄alkyl, vinyl or cyclopropyl; R₂ is hydrogen, fluorine or chlorine; R₃ is fluorine or chlorine; R₄ is hydrogen or methyl; and X is oxygen or methylene;

(20) compounds of formula Ic wherein n is 1 or 2, and when n is 2 the two radicals R₃ are identical or different; R₁ is C₁-C₄alkyl; R₂ is hydrogen or chlorine; R₃ is fluorine or chlorine; R₄ is hydrogen or methyl; and X is oxygen or methylene;

(21) compounds of formula Ic wherein n is 1 or 2, and when n is 2 the two radicals R₃ are identical or different; R₁ is C₁-C₃alkyl; R₂ is hydrogen; R₃ is fluorine or chlorine; R₄ is hydrogen; and X is oxygen.

Specific preference is given to the following compounds of formula I:

2-cyclopropyl-4-[4-(phenoxy)-phenoxymethyl]-1,3-dioxolane;

4-(2-chloro-4-phenoxy-phenoxymethyl)-2-ethyl-1,3-dioxolane;

4-(2-chloro-4-phenoxy-phenoxymethyl)-2-propyl-1,3-dioxolane;

4-(2-chloro-4-phenoxy-phenoxymethyl)-2-isopropyl-1,3-dioxolane;

4-(2-chloro-4-phenoxy-phenoxymethyl)-2-cyclopropyl-1,3-dioxolane;

4-[2-chloro-4-(3-fluorophenoxy)-phenoxymethyl]-2-ethyl-1,3-dioxolane;

4-[2-chloro-4-(3-fluorophenoxy)-phenoxymethyl]-2-propyl-1,3-dioxolane;

4-[2-chloro-4-(3-fluorophenoxy)-phenoxymethyl]-2-isopropyl-1,3-dioxolane;

4-[2-chloro-4-(3-fluorophenoxy)-phenoxymethyl]-2-cyclopropyl-1,3-dioxolane;

4-[2-chloro-4-(3-chlorophenoxy)-phenoxymethyl]-2-ethyl-1,3-dioxolane;

4-[2-chloro-4-(3-chlorophenoxy)-phenoxymethyl]-2-propyl-1,3-dioxolane;

4-[2-chloro-4-(3-chlorophenoxy)-phenoxymethyl]-2-isopropyl-1,3-dioxolane;

4-[2-chloro-4-(3,5-difluorophenoxy)-phenoxymethyl]-2-ethyl-1,3-dioxolane;

4-[2-chloro-4-(3,5-difluorophenoxy)-phenoxymethyl]-2-propyl-1,3-dioxolane;

4-[2-chloro-4-(3,5-difluorophenoxy)-phenoxymethyl]-2-isopropyl-1,3-dioxolane;

4-[2-chloro-4-(3,4-dichlorophenoxy)-phenoxymethyl]-2-ethyl-1,3-dioxolane;

4-[2-chloro-4-(3-chloro-4-fluorophenoxy)-phenoxymethyl]-2-ethyl-1,3-dioxolane;

4-(2-chloro-4-benzyl-phenoxymethyl)-2-ethyl-1,3-dioxolane;

4-(2-chloro-4-benzyl-phenoxymethyl)-2-propyl-1,3-dioxolane;

4-(2-chloro-4-benzyl-phenoxymethyl)-2-isopropyl-1,3-dioxolane;

4-(2-chloro-4-benzyl-phenoxymethyl)-2-cyclopropyl-1,3-dioxolane;

4-[2-chloro-4-(3-fluorobenzyl)-phenoxymethyl]-2-ethyl-1,3-dioxolane;

4-[2-chloro-4-(3-fluorobenzyl)-phenoxymethyl]-2-propyl-1,3-dioxolane;

4-[2-chloro-4-(3,5-difluorobenzyl)-phenoxymethyl]-2-ethyl-1,3-dioxolane;

4-[2-chloro-4-(3,4-dichlorobenzyl)-phenoxymethyl]-2-ethyl-1,3-dioxolane;

2-ethyl-4-[4-(3-fluorophenoxy)-phenoxymethyl]-4-methyl-1,3-dioxolane;

2-ethyl-4-[4-(3-fluorophenoxy)-phenoxymethyl]-1,3-dioxolane and

4-[4-(3,5-difluorophenoxy)-phenoxymethyl]-2-isopropyl-1,3-dioxolane; but especially to:

2-dimethyl-4-[4-(3-fluorophenoxy)-phenoxymethyl]-1,3-dioxolane and

2-dimethyl-4-[4-(3,5-difluorophenoxy)-phenoxymethyl]-1,3-dioxolane.

The compounds of formula I are known per se or can be prepared, for example, according to European Patent No. 559 612.

The compounds of formula I are known to be active against ectoparasites when applied topically (EP 559 612) in that they inhibit or completely suppress the further development of juvenile stages of development; however, that action has always been determined on direct application of the active ingredient to the parasites. What is astonishing in connection with the present invention, however, is that full activity is still achieved even when the active ingredient is administered to the host animal in relatively low concentrations and reaches the adult parasite only by the circuitous route via the blood sucked up by the parasite.

The parasites to be controlled can be reached by the substances in two ways. On the one hand, chemicals can be taken up by the adult parasite via the ingested blood and be passed on from the adult parasite to the eggs, where the activity of the chemicals then manifests itself. Death may then occur in the egg, larval or pupal stage. Tests on parasites show reduced oviposition, high mortality of the larvae and, in the case of the pupal stage, an inhibition of hatching ability. On the other hand, the larvae are exposed to the effect of the excreta of the adult parasites, since they live on that excrement. The parasites' excreta still comprise large amounts of undigested blood from the host animal and serve as a source of protein for the developing parasites.

The present invention thus has two objectives, on the one hand the afore-described method for the prevention of the reinfestation of dogs and cats by ectoparasites, and simultaneously of course the inhibition of the reproduction of ectoparasites or, more precisely: a method for the prevention of the reproduction of ectoparasites, which comprises administering to the ectoparasites as food blood that comprises an effective amount of at least one of the active ingredients defined above. This method also includes the objective of an effective amount of one of the said active ingredients being administered to the host animal in the food and the ectoparasites ingesting the active ingredient by taking in the animal's blood on sucking blood.

It is material to the invention that the active ingredient selected from the mentioned class of compounds of formula I be administered in such a manner that it is taken up by the adult, sucking parasite with the blood of the host animal and can take effect in the juvenile stages. This is achieved according to the invention using various forms of administration, for example by administering a formulated active ingredient orally. “Formulated” in this case means, for example, in the form of a powder, a tablet, granules, a capsule, an emulsion, a foam, etc.; the animal need not necessarily be given the composition directly, rather it is advantageously mixed with its food. In addition to customary formulation ingredients, any composition that is to be administered orally may of course comprise further adjuvants that encourage the host animal to take the composition voluntarily, for example suitable odorants and flavourings. Oral administration, being easy to carry out, is one of the preferred subjects of this invention. A further form of administration is parenteral administration, for example by subcutaneous injection or intravenous injection, or with a long-term composition (depot form) in the form of an implant.

Oral administration includes, for example, the administration of animal food ready mixed with the active ingredient, for example in the form of biscuits or treats, chewable tablets, water-soluble capsules or tablets, in a water-soluble form that can be added to the food in the form of drops or in other forms that can be mixed with the animal food. The implants also include any means that can be introduced into the body of the animal in order to release active ingredient.

Percutaneous forms of administration include, for example, subcutaneous, dermal, intra-muscular and even intravenous administration of injectable forms. In addition to the customary syringes with needles, needle-less high-pressure syringe devices, as well as pour-on and spot-on formulations, may be expedient.

By selection of a suitable formulation, it is possible to enhance the ability of the active ingredient to penetrate through the living tissue of the animal, and/or to maintain its availability. That is important when, for example, a very sparingly soluble active ingredient is used, the low solubility of which requires means for enhancing solubility, since the animal's body fluid is capable of dissolving only small amounts of active ingredient at a time.

The active ingredient may also be present in a matrix formulation which physically prevents the active ingredient from decomposing and maintains the constant availability of active ingredient. The matrix formulation is injected into the body and remains there as a form of depot from which active ingredient is released continuously. Such matrix formulations are known to a person skilled in the art. They are generally wax-like, semi-solid substances, for example vegetable waxes and polyethylene glycols having a high molecular weight.

A high degree of active ingredient availability is also obtained by the introduction of an implant of the active ingredient into the animal. Such implants are widely used in veterinary medicine and often consist of silicone-containing rubber. The active ingredient is dispersed in the solid rubber or is located inside a hollow rubber body. Care must be taken that the active ingredient selected is soluble in the rubber implant, since it is first dissolved in the rubber and then seeps continuously out of the rubber material and into the body fluid of the animal to be treated.

The rate of release of the active ingredient from the implant, and thus the length of time during which the implant exhibits activity, is generally determined by the accuracy of the calibration of the implant (amount of active ingredient in the implant), the environment of the implant and the polymer formulation from which the implant has been produced.

Administration of the active ingredient by means of an implant is a further preferred component of the present invention. Such administration is extremely economical and effective, because a correctly dimensioned implant ensures that the concentration of active ingredient in the tissue of the host animal is constant. It is possible nowadays for implants to be so made and implanted in a simple manner that they are capable of delivering the active ingredient over a period of several months. Once the implant has been made, the animal is not disturbed further, and there is no further need to be concerned about the dosage.

The administration of veterinary medicinal additives to animal food is well known in the field of animal health. It is usual first to prepare a so-called premix in which the active ingredient is dispersed in a liquid or is in finely divided form in solid carriers. That premix can normally comprise about 1 to 800 g of compound per kg of premix, depending on the desired final concentration in the food.

It is also known that active ingredients may be hydrolysed or weakened by the constituents of the food. Such active ingredients are routinely formulated in a protective matrix, for example in gelatin, before being added to the premix.

The present invention therefore relates also to a method for the systemic prevention of the reinfestation of host animals by ectoparasites, which comprises administering to the said host animal orally, parenterally or by means of an implant a larvicidally or ovicidally effective amount of a compound that inhibits the growth of the ectoparasites, preferably a method in which a compound of formula I is used as a compound that inhibits the growth of the ectoparasites.

Accordingly, the present invention relates also to a method for the prevention of the reproduction of ectoparasites, which comprises making available to the ectoparasites as food blood that comprises an effective amount of a parasite-growth-inhibiting compound selected from the compounds of formula I. In other words, the present invention relates also to a method for the prevention of the reproduction of ectoparasites living on host animals, which comprises administering an effective amount of one of the parasite-growth-inhibiting compounds of formula I to the host animal in the form of a fee d additive and in that way enabling that compound to reach the parasites living on the host animal.

The compound of formula I is advantageously administered in a dose of from 0.01 to 800 mg/kg, preferably from 0.5 to 200 mg/kg, especially from 1 to 30 mg/kg of body weight, based on the host animal, with oral administration being preferred. A good dose that can be administered to the host animal regularly is from 1 to 100 mg/kg of body weight. Administration is advantageously effected daily, weekly, monthly or half-yearly. For the same active ingredient, the total dose may vary from one species of animal to another as well as within a species of animal, since it depends inter alia on the weight and constitution of the animal.

When used according to the invention, the active ingredient will not normally be administered in pure form, but preferably in the form of a composition that comprises, in addition to the active ingredient, constituents that assist administration, suitable constituents being those that are tolerated by the host animal. It is of course possible, as well as controlling the juvenile stages of development in accordance with the invention, additionally to use conventional methods to control the adult ectoparasites, although the latter is not absolutely essential.

Such compositions to be administered in accordance with the invention generally comprise from 0.1 to 99% by weight, especially from 0.1 to 95% by weight, of a compound of formula I and from 99.9 to 1% by weight, especially from 99.9 to 5% by weight, of a solid or liquid, non-toxic adjuvant, including from 0 to 25% by weight, especially from 0.1 to 25% by weight, of a non-toxic surfactant.

Whereas commercial products will preferably be formulated as concentrates, the end user will normally employ dilute formulations. Such formulations may also comprise further auxiliaries, such as stabilisers, antifoams, viscosity regulators, binders and tackifiers as well as other active ingredients for obtaining special effects. The materials known from veterinary medicinal practice for oral and parenteral administration and for implants can be used as formulation excipients. Some examples are given below.

Suitable carriers are especially fillers, such as sugars, for example lactose, saccharose, mannitol or sorbitol, cellulose preparations and/or calcium phosphates, for example tricalcium phosphate or calcium hydrogen phosphate, and binders, such as starch pastes using, for example, corn, wheat, rice or potato starch, gelatin, tragacanth, methylcellulose and/or, if desired, disintegrators, such as the above-mentioned starches, also carboxymethyl starch, cross-linked polyvinylpyrrolidone, agar, alginic acid or a salt thereof, such as sodium alginate. Adjuvants are especially flow conditioners and lubricants, for example silicic acid, talc, stearic acid or salts thereof, such as magnesium or calcium stearate, and/or polyethylene glycol. Dragée cores can be provided with suitable, optionally enteric, coatings, there being used inter alia concentrated sugar solutions which may comprise gum arabic, talc, polyvinylpyrrolidone, polyethylene glycol and/or titanium dioxide, or coating solutions in suitable organic solvents or solvent mixtures, or, for the preparation of enteric coatings, solutions of suitable cellulose preparations, such as acetylcellulose phthalate or hydroxypropylmethylcellulose phthalate. Dyes, flavourings or pigments may be added to the tablets or dragee coatings, for example for identification purposes or to indicate different doses of active ingredient.

Other orally administrable compositions are hard gelatin capsules, and also soft sealed capsules made of gelatin and a plasticiser, such as glycerol or sorbitol. The hard gelatin capsules may comprise the active ingredient in the form of granules, for example in admixture with fillers, such as lactose, binders, such as starches, and/or glidants, such as talc or magnesium stearate, and, if desired, stabilisers. In soft capsules, the active ingredient is preferably dissolved or suspended in suitable liquids, such as fatty oils, paraffin oil or liquid polyethylene glycols, to which stabilisers may also have been added. Preference is given inter alia to capsules that may easily be bitten through or swallowed without being chewed.

Suitable for parenteral administration are especially aqueous solutions of an active ingredient in water-soluble form, for example in the form of a water-soluble salt, and also suspensions of the active ingredient, such as corresponding oily injection suspensions, there being used suitable lipophilic solvents or vehicles, such as fatty oils, for example sesame oil, or synthetic fatty acid esters, for example ethyl oleate, or triglycerides, or aqueous injection suspensions that comprise viscosity-increasing substances, for example sodium carboxymethylcellulose, sorbitol and/or dextran, and, optionally, stabilisers.

The compositions of the present invention can be prepared in a manner known per se, for example by means of conventional mixing, granulating, confectioning, dissolving or lyophilising processes. For example, compositions for oral administration can be obtained by combining the active ingredient with solid carriers, optionally granulating a resulting mixture, and processing the mixture or granules, if desired or necessary after the addition of suitable excipients, to form tablets or dragee cores.

The following Examples illustrate the invention described above, but do not limit its scope in any way. Temperatures are given in degrees Celsius.

### EXAMPLE 1

Tablets comprising 25 mg of active ingredient can be prepared as follows:

Constituents (for 1000 tablets)

| | | |
|---|---|---|
| active ingredient | 25.0 | g |
| lactose | 100.7 | g |
| wheat starch | 7.5 | g |
| polyethylene glycol 6000 | 5.0 | g |
| talcum | 5.0 | g |
| magnesium stearate | 1.8 | g |

| | |
|---|---|
| demineralised water | q.s. |

Preparation: All the solid ingredients are first forced through a sieve having a mesh size of 0.6 mm. Then the active ingredient, the lactose, the talcum, the magnesium stearate and half the starch are mixed together. The other half of the starch is suspended in 40 ml of water and the suspension is added to a boiling solution of the polyethylene glycol in 100 ml of water. The resulting starch paste is added to the main batch and the mixture is granulated, if necessary with the addition of water. The granules are dried overnight at 35°, forced through a sieve having a mesh size of 1.2 mm and compressed to form tablets which have a diameter of about 6 mm and which are concave on both sides.

### EXAMPLE 2

Tablets comprising 0.02 g of active ingredient are prepared as follows:

Composition (for 10 000 tablets)

| | | |
|---|---|---|
| active ingredient | 200.00 | g |
| lactose | 290.80 | g |
| potato starch | 274.70 | g |
| stearic acid | 10.00 | g |
| talc | 200.00 | g |
| magnesium stearate | 2.50 | g |
| colloidal silica | 32.00 | g |

| | |
|---|---|
| ethanol | q.s. |

A mixture of the active ingredient, the lactose and 194.70 g of potato starch is moistened with an ethanolic solution of the stearic acid and granulated through a sieve. After drying, the remaining potato starch, the talc, the magnesium stearate and the colloidal silica are mixed in and the mixture is compressed to form tablets each weighing 0.1 g, which may, if desired, be provided with dividing notches for finer adaptation of the dose.

### EXAMPLE 3

Capsules comprising 0.025 g of active ingredient can be prepared as follows:

Composition (for 1000 capsules)

| | | |
|---|---|---|
| active ingredient | 50.00 | g |
| lactose | 249.80 | g |
| gelatin | 2.00 | g |
| corn starch | 10.00 | g |
| talc | 15.00 | g |

| | |
|---|---|
| water | q.s. |

The active ingredient is mixed with the lactose, and the mixture is moistened uniformly with an aqueous solution of the gelatin and granulated through a sieve having a mesh size of 1.2-1.5 mm. The granules are mixed with the dried corn starch and the talc and introduced in 300 mg portions into hard gelatin capsules (size 1).

### EXAMPLE 4

Premix (feed additive)

0.25 part by weight of active ingredient and

4.75 parts by weight of secondary calcium phosphate, alumina, Aerosil, carbonate or chalk are mixed until homogeneous with

95 parts by weight of an animal food.

### EXAMPLE 5

Emulsifiable concentrate

20 parts by weight of active ingredient are mixed with

20 parts by weight of the emulsifier, e.g. a mixture of alkylarylpolyglycol ether with alkylarylpolysulfonates, and with

60 parts by weight of a solvent until the solution has been completely homogenised. Emulsions of the desired concentration are obtained by dilution with water.

### EXAMPLE 6

Solutions (e.g. for use as a drink additive)

15 percent by weight active ingredient in 2,2-dimethyl-4-hydroxymethyl-1,3-dioxolane,

10 percent by weight active ingredient in diethylene glycol monoethyl ether,

10 percent by weight in polyethylene glycol 300, and

5 percent by weight in glycerol.

### EXAMPLE 7

Soluble powder

25 parts by weight of active ingredient,

1 part by weight of sodium lauryl sulfate,

3 parts by weight of colloidal silica gel, and

71 parts by weight of urea.

The constituents are mixed together and ground with one another until homogeneous.

Further biologically active compounds or ingredients that are neutral towards the active ingredients and that have no adverse effect on the host animal to be treated, as well as mineral salts or vitamins, can be added to the compositions described.

Other compositions comprising compounds of formula I can also be prepared analogously to the described formulations of Examples 1 to 7.

### EXAMPLE 8

Flea control by oral administration of the active ingredient to the host animal

20 cats with the proven ability permanently to maintain a flea population are divided into 6 groups: 5 groups each being composed of 3 or 4 animals and a sixth group, which serves as the control group, being composed of 2 animals. Each of the cats is infected with 100 cat fleas [Ctenocephalides felis]. The cats of the 5 groups are treated orally on day 0 with 50 mg of active ingredient per kg of body weight. The active ingredient is administered in the form of a capsule. The control group remains untreated.

After 3, 8 and 10 days, the flea eggs are collected from the paper beneath the cats' boxes. The eggs are counted and placed on a medium suitable for the growth of larvae and incubated. The number of pupae and fully grown fleas that develop is determined.

Compounds of formula I exhibit good activity in this test. In particular, 4-[4-(3-fluorophenoxy)-phenoxymethyl]-2-ethyl-1,3-dioxolane, 4-[4-(3,5-difluorophenoxy)-phenoxymethyl]-2-isopropyl-1,3-dioxolane, 2-dimethyl-4-[4-(3-fluorophenoxy)-phenoxymethyl]-1,3-dioxolane and 2-dimethyl-4-[4-(3,5-difluorophenoxy)-phenoxymethyl]-1,3-dioxolane still exhibit 100% inhibition of the development of fleas after 45 days.

### EXAMPLE 9

Tick control by subcutaneous administration of the active ingredient to the host animal

13 day-old chicks of a fattened breed are infected with about 200 larvae of the tick species Amblyomma hebraeum and placed in pairs in cages. After three days, the chicks are injected subcutaneously with the active ingredient in an aqueous suspension. Within 2 to 6 days of the treatment, i.e. 5 to 9 days after infection, the replete tick larvae fall from the chicks can be collected and counted. The activity of the test compounds is calculated on the basis of the number of replete larvae on treated and untreated chicks in accordance with the formula

$$\% control = ( 1 - \frac{Ct}{Cu} ) * 100$$

where Ct is the average number of larvae from treated chicks and Cu is the average number of larvae from untreated chicks.

Active ingrediants that have a growth-inhibiting action on tick larvae do not exhibit their activity until the larvae have moulted to form nymphs. In order to determine this type of activity, the replete larvae are kept, separated into treatment groups, in an incubator until all the larvae collected from untreated chicks have moulted. The activity is calculated using the above mentioned formula, with the average number of nymphs being used instead of the average number of larvae.

Table 1 shows the activity of a subcutaneously injected dose of 3 mg of the active ingredient per kg of body weight on the larvae and nymph formation of Amblyomma hebraeum in chicks. Reduction of more than + 80 % can be regarded as systemic action.

| Compound¹⁾ | % reduction larvae | % reduction nymphs |
|---|---|---|
| 1 | 83 | 83 |
| 2 | 82 | 83 |
| 3 | 78 | 80 |

¹⁾compound 1: 2-ethyl-4-[4-(3-fluorophenoxy)-phenoxymethyl]-4-methyl-1,3-dioxolane
compound 2: 2-cyclopropyl-4-[4-(phenoxy)-phenoxymethyl]-1,3-dioxolane
compound 3: 2-ethyl-4-[4-(3-fluorophenoxy)-phenoxymethyl]-1,3-dioxolane

compound 1: 2-ethyl-4-[4-(3-fluorophenoxy)-phenoxymethyl]-4-methyl-1,3-dioxolane

compound 2: 2-cyclopropyl-4-[4-(phenoxy)-phenoxymethyl]-1,3-dioxolane

compound 3: 2-ethyl-4-[4-(3-fluorophenoxy)-phenoxymethyl]-1,3-dioxolane

What is claimed is:

1. A method for the systemic control of blood-sucking parasites in warm-blooded animals or for the prevention of reinfestation, wherein a compound of formula 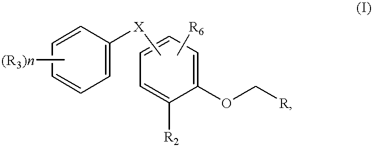
wherein
n is 0, 1, 2 or 3, and when n is greater than 1 the radicals R₃ are identical or different;
R is C(CH₃)═CHCOOR₇, wherein R₇ is C₁-C₆alkyl; C(CH₃)═CHC(═O)R₈, wherein R₈ is C₁-C₆alkyl, NH-C₁-C₆alkyl or N(C₁-C₆alkyl)₂; CH₂C(CH₃)(R₉)-OR₁₀, wherein R₉ and R₁₀ are each independently of the other H or C₁-C₆alkyl; phenyl that is substituted from one to five times, the substituents being selected from the group consisting of hydrogen, C₁-C₆alkyl, C₁-C₆alkoxy and halogen; pyridyl that is unsubstituted or substituted from one to four times, the substituents being selected from the group consisting of hydrogen, C₁-C₆alkyl and halogen; CH(R₁₁)OC(═O)NHR₁₂, wherein R₁₁ is hydrogen or methyl and R₁₂ is C₁-C₆alkyl; CH₂OC(═O)N(R₁₃)R₁₄, wherein R₁₃ and R₁₄ are each independently of the other hydrogen or C₁-C₆alkyl; CH₂NHCOOR₁₅, wherein R₁₅ is C₁-C₆alkyl; CH₂CH₂C≡CH; C≡CH; CH(R₁₆)ZR₁₇, wherein R₁₆ is hydrogen or C₁-C₆alkyl, Z is oxygen or sulfur and R₁₇ is a five- or six-membered, aromatic or non-aromatic ring containing from one to three nitrogen atoms; 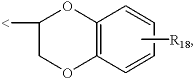
, wherein R₁₈ is hydrogen or C₁-C₆alkyl; 1,4-dioxane that is unsubstituted or substituted from one to seven times by C₁-C₆alkyl; or 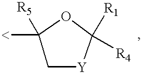
, wherein either R₁ is C₁-C₆alkyl, halo-C₁-C₃alkyl, C₂-C₄alkenyl, C₂-C₄alkynyl, C₁-C₃alkoxy or C₃-C₆cycloalkyl and R₄ is hydrogen or C₁-C₃alkyl; or R₁ and R₄, together with the carbon atom to which R₁ and R₄ are bonded, form a ring having 4, 5 or 6 ring members, the ring structure, which may contain a carbon-carbon double bond, being composed either only of carbon atoms or of 1 oxygen atom and 3, 4 or 5 carbon atoms and the ring being unsubstituted or mono- or di-substituted by identical or different C₁-C₃alkyl radicals; R₅ is hydrogen or C₁-C₃alkyl; and Y is nitrogen, oxygen or sulfur;
R₂ is hydrogen, C₁-C₃alkyl, halo-C₁-C₃alkyl, C₂-C₃alkenyl, C₁-C₃alkoxy, halo-C₁-C₃alkoxy, fluorine, chlorine or bromine;
R₃ is C₁-C₃alkyl, halo-C₁-C₃alkyl, C₁-C₃alkoxy, halo-C₁-C₃alkoxy, fluorine, chlorine or bromine;
R₆ is hydrogen, halogen or C₁-C₃alkyl; and
X is methylene, O, S or C(═O),
is administered systemically to the warm-blooded animal in an amount that affects the growth of one of the early stages of development of the parasite in such a manner that the parasite does not reach the adult stage or that the adult parasite is rendered sterile.

2. A method according to claim 1, wherein the early stages of development are eggs, larvae or pupae of the blood-sucking parasite.

3. A method according to claim 1, wherein the blood-sucking parasite loses its ability to produce eggs.

4. A method according to claim 1, wherein the blood-sucking parasites are insects or parasites of the order Acarina.

5. A method according to claim 1, wherein “insects” is to be understood as meaning lice, biting flies, bluebottles, mosquitos, dog fleas or cat fleas.

6. A method according to claim 1, wherein “parasites of the order Acarina” is to be understood as meaning ticks and mites.

7. A method according to claim 1, wherein the compound of formula I is administered in a formulated form.

8. A method according to claim 7, wherein “formulated form” is to be understood as meaning a systemically administrable composition comprising the active ingredient and at least one physiologically tolerable formulation excipient.

9. A method according to claim 8, wherein the formulated form is a tablet, a capsule, granules, a drinkable solution or emulsion, an injectable solution, a bolus, a depot preparation, a gel or a feed additive.

10. A method according to claim 1, wherein the compound of formula I or a veterinary medicinal composition comprising the said compound is administered to the warm-blooded animal parenterally, via an implant or orally.

11. The use of a compound of formula I according to claim 1 in the systemic control of blood-sucking parasites in warm-blooded animals, wherein the compound of formula I is delivered to the blood-sucking parasite via the bloodstream of the warm-blooded animal in an amount that either sterilises the parasite or acts on the early stages of development of its progeny in such a manner that those progeny do not reach the adult stage.

12. A process for the preparation of a veterinary medicinal composition for controlling blood-sucking parasites that can be administered systemically to a warm-blooded animal, which comprises mixing a compound of formula I according to claim 1 with at least one physiologically tolerable formulation excipient.

13. The use of a compound of formula I according to claim 1 in the preparation of a veterinary medicinal composition that can be administered systemically to warm-blooded animals for controlling blood-sucking parasites or for preventing reinfestation of the warm-blooded animal.
